(19) United States
(12) Patent Application Publication
(10) Pub. No.: US 2002/0065564 A1
(43) Pub. Date: May 30, 2002

(54) Digital content management system

(76) Inventors: Amyn A. Sheriff, Los Altos Hills, CA (US); Aziz A. Sheriff, Claremont, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/904,577

(22) Filed: Jul. 12, 2001

Related U.S. Application Data
(60) Provisional application No. 60/218,107, filed on Jul. 13, 2000.

(51) Int. Cl. G05B 11/01

(52) U.S. Cl. 700/11

(57) ABSTRACT

Aspects of embodiments of the invention include a digital content management system providing content synchronization and content continuation over multiple presentation devices, including stationary and mobile presentation devices. According to one embodiment, the content continues from a first device to a second device when the first device is deactivated. According to another embodiment, the content continues from a first device to a second device when the second device is activated.

### REFERENCE TO RELATED APPLICATION

The present application claims priority benefit under 35 U.S.C. §119(e) from U.S. Provisional Application No. 60/218,107 filed Jul. 13, 2000 entitled “SYSTEM AND METHOD FOR LOCALLYACCESSING INFORMATION WITHA MOBILE DEVICE,” which is herewith incorporated by reference.

### BACKGROUND OF THE INVENTION

1. Field of the Invention

Aspects of certain embodiments of the invention relate generally to the management of digital content, and particularly to a mobile digital content management device.

2. Description of the Related Art

An increasing number of people and businesses around the world use the Internet every day to communicate with others, follow the stock market, keep up with the news, check the weather, make travel plans, conduct business, shop, and learn. These activities require users and their computing devices to manage and exchange an increasing amount of digital content, such as digital music files, emails, voicemails, digital movies, news clips, weather reports, stock prices, and the like. Accordingly, management of the foregoing digital content is becoming an increasingly important and an increasingly difficult task.

As a result, several technologies have developed which attempt to manage specific types of digital content between a user's personal computer and one or more specific mobile computing devices. For example, mobile MP3 players typically allow a user to load digital music from a personal computer to the player, thereby enabling the user to listen to his or her digital content without accessing the personal computer. Personal Digital Assistants (PDAs) also allow a user to manage digital content between one or more personal computers and the PDA. For example, users often view emails, schedules, tasks, and contact information without accessing the personal computer. While each of the foregoing devices attempt to efficiently manage digital content between a user's personal computer and the mobile device, the content specific devices often do not interact with one another and often do not allow seamless access to varying types of digital content.

Another technology attempting to manage digital content is the mobile phone technology. Mobile phone technology often allows users access to a variety of differing types of digital content through their telephone, such as, for example, receiving news, weather reports, stock prices, emails, pages, and the like. Moreover, some mobile phones also provide on-line browsing. However, mobile phone technology typically does not conveniently or efficiently provide users the ability to transfer the foregoing varied digital content to other computing devices.

### SUMMARY OF THE INVENTION

Based on the foregoing, a need exists for a computing system that conveniently and efficiently provides management and exchange of digital content between multiple stationary and mobile devices. Accordingly, one aspect of an embodiment includes a digital content management system comprising content managers, such as residential or commercial content managers, which communicate with one or more stationary or mobile digital content management devices. According to another embodiment, the digital content management system provides for continuous content presentation, as well as content synchronization, between various devices within the system. According to another embodiment, the digital content management system provides for automatic content synchronization and manual content synchronization, between various devices within the system.

According to yet another embodiment, the digital content management system comprises a commercial content manager adapted to communicate commercial content to one or more mobile digital content management devices. For example, the commercial content manager may advantageously transmit menu content for a restaurant, cross marketing content for almost any number of products or services, wireless billboard content, or the like. Moreover, the foregoing commercial content may advantageously be geographically relevant to the location of a particular mobile digital content management device.

According to yet another embodiment, the digital content management system comprises a mobile digital content management device capable of communicating with numerous other devices, including, for example, emergency vehicles to indicate a location thereof or alert a user of the presence of the same, automobile computers to determine diagnostics or other parameters thereof, camera or sound recording devices to monitor the surrounding or parameters of an automobile during, for example, an accident, or the like.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

The present invention is described in more detail below in connection with the attached drawings, which are meant to illustrate and not to limit the invention, and in which:

FIG. 1 illustrates a block diagram of a digital content management system, according to aspects of an embodiment of the invention;

FIG. 2 illustrates a block diagram of a digital content management device of FIG. 1, according to aspects of an embodiment of the invention;

FIG. 3 illustrates a block diagram of various functional modules adaptable for use with the digital content management device of FIG. 2, according to aspects of an embodiment of the invention;

FIGS. 4-5 illustrate screen displays of a content synchronization program of the management device of FIG. 1, according to aspects of an embodiment of the invention;

FIG. 6 illustrates a flowchart of a content continuation process, according to aspects of an embodiment of the invention;

FIG. 7 illustrates a simplified view of a human interface device of a digital content management device of FIG. 1, according to aspects of an embodiment of the invention;

FIGS. 8-9 illustrate screen displays of the human interface device of FIG. 7, according to aspects of an embodiment of the invention;

FIG. 10 illustrates a block diagram of a commercial wireless transmission system, according to aspects of an embodiment of the invention;

FIG. 11 illustrates a flowchart of a wireless drive-through process, according to aspects of an embodiment of the invention;

FIG. 12 illustrates a screen display of a human interface device connected to the mobile digital content management device of FIG. 10, according to aspects of an embodiment of the invention;

FIG. 13 illustrates a flowchart of a commercial cross-marketing process, according to aspects of an embodiment of the invention;

FIG. 14 illustrates a flowchart of a commercial content transmission process, according to aspects of an embodiment of the invention;

FIG. 15 illustrates a block diagram of another commercial wireless transmission system, according to aspects of an embodiment of the invention;

FIG. 16 illustrates a block diagram of a mobile digital content management device having an emergency or utility warning system, according to aspects of an embodiment of the invention;

FIG. 17 illustrates a flowchart of an emergency warning process, according to aspects of an embodiment of the invention;

FIG. 18 illustrates a simplified view of a parking assistance device, according to aspects of an embodiment of the invention; and

FIG. 19 illustrates an accident recording process, according to aspects of an embodiment of the invention.

### DETAILED DESCRIPTION OF THE PREFERRED EMBODIMENT

To facilitate the complete understanding of the invention, the remainder of the detailed description describes the invention with reference to the Figures, wherein like elements are referenced with like numerals throughout.

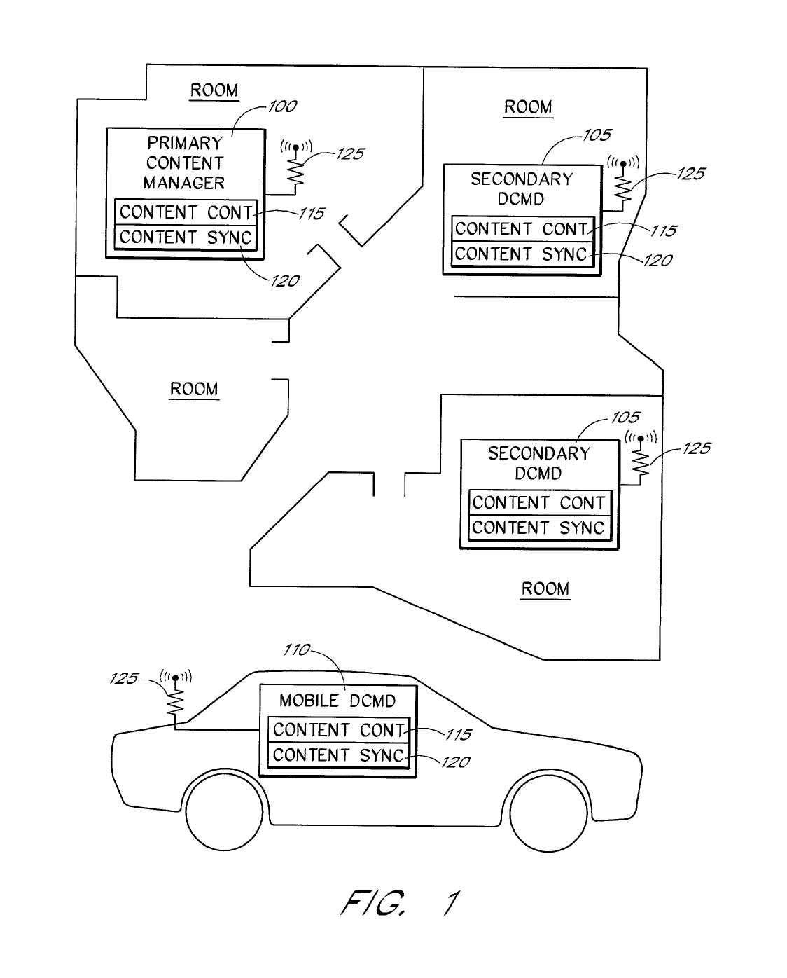

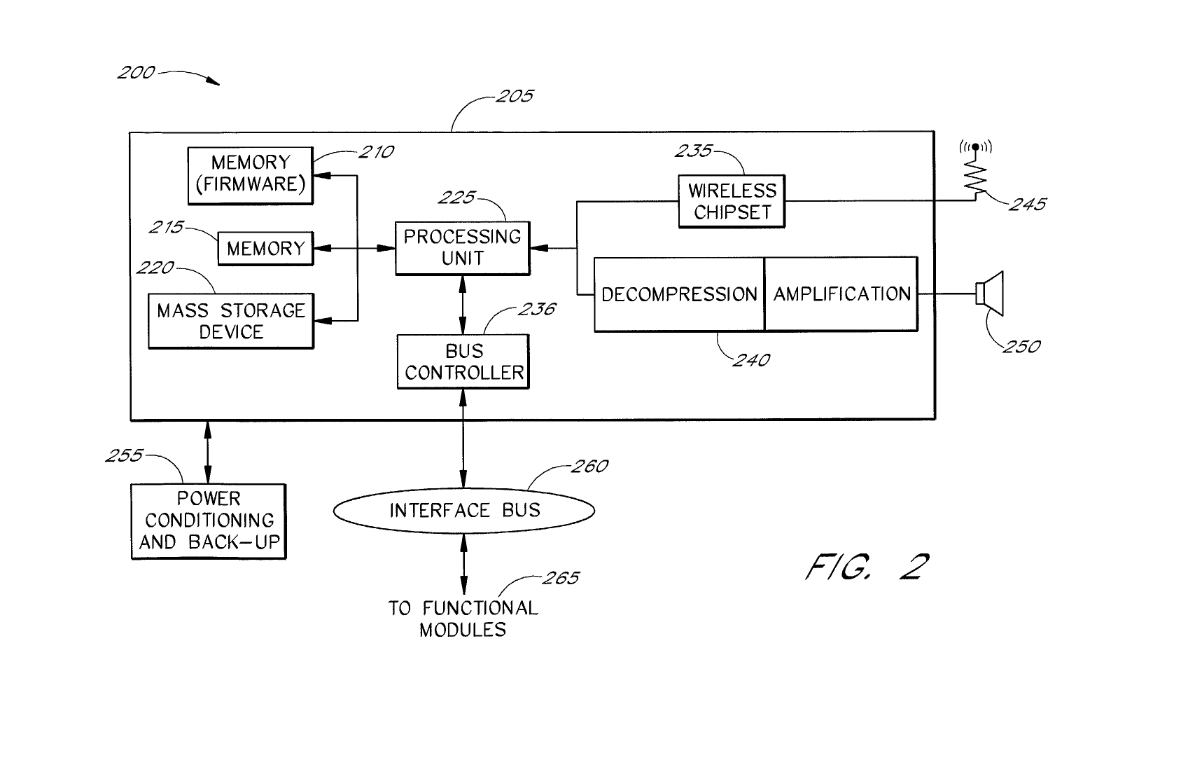

FIG. 1 illustrates a block diagram of a digital content management system (DCMS) according to aspects of an embodiment of the invention. As shown in FIG. 1, the digital content management system includes a primary content manager 100. In one embodiment of the invention, the digital content management system includes the primary content manager 100 and one or more secondary digital content management devices (Secondary DCMDs) 105. In another embodiment of the invention, the digital content management system includes the primary content manager 100 and one or more mobile digital content management devices (Mobile DCMDs) 110. As used herein, a digital content management device (DCMD) includes its ordinary meaning, such as, for example, virtually any computing device capable of communicating with one or more alternative devices, including, for example, the DCMD described with reference to FIG. 2, or the like.

As illustrated in FIG. 1, the primary content manager 100 includes a content continuation module 115 and a content synchronization module 120. As illustrated in FIG. 1, the secondary DCMD includes the content continuation module 115 and the content synchronization module 120. As illustrated in FIG. 1, the mobile DCMD 100 includes a content continuation module 115 and a content synchronization module 120. As illustrated in FIG. 1, the primary content manager 100, the secondary DCMD 105 and the mobile DCMD 110 includes a transmission device 125.

According to one embodiment, the primary content manager 100 comprises a conventional general purpose computer using one or more microprocessors such as, for example, an Intel-based processor. Moreover, the primary content manager 100 includes an appropriate operating system such as, for example, an operating system capable of displaying text or graphics, such as Microsoft Windows, Unix, Linux, or the like. As shown in FIG. 1, the primary content manager 100 includes the content continuation module 115. The content continuation module 115 advantageously allows for content to be played continuously between the primary content manager 100 and the secondary DCMD 105 and the mobile DCMD 110.

The term content, as used herein, is a broad term and shall have its ordinary meaning, including without limitation, email, voicemail, news, stock quotes, driving directions, audio books or compact discs, and on-line streamed media. The content may be of any nature including, without limitation, electronic, analog, digital, or part analog and part digital. The content may take any form or configuration. The DCMD is configured to present content, store content for later or multiple presentations, or both.

In one embodiment of the invention, the content continuation module 115 advantageously includes software which presents content and maintains a record of the current presentation location within the content. In one embodiment of the invention, the content continuation module 115 transmits the position of the content being presented. In another embodiment of the invention, the content continuation module 115 transmits a channel identification code representing the content currently being presented. In another embodiment of the invention, the content continuation module 115 receives a record indicating the content being presented and the current position of the content. In another embodiment of the invention, the content continuation module 115 receives a record indicating the channel identification code representing the content currently being presented.

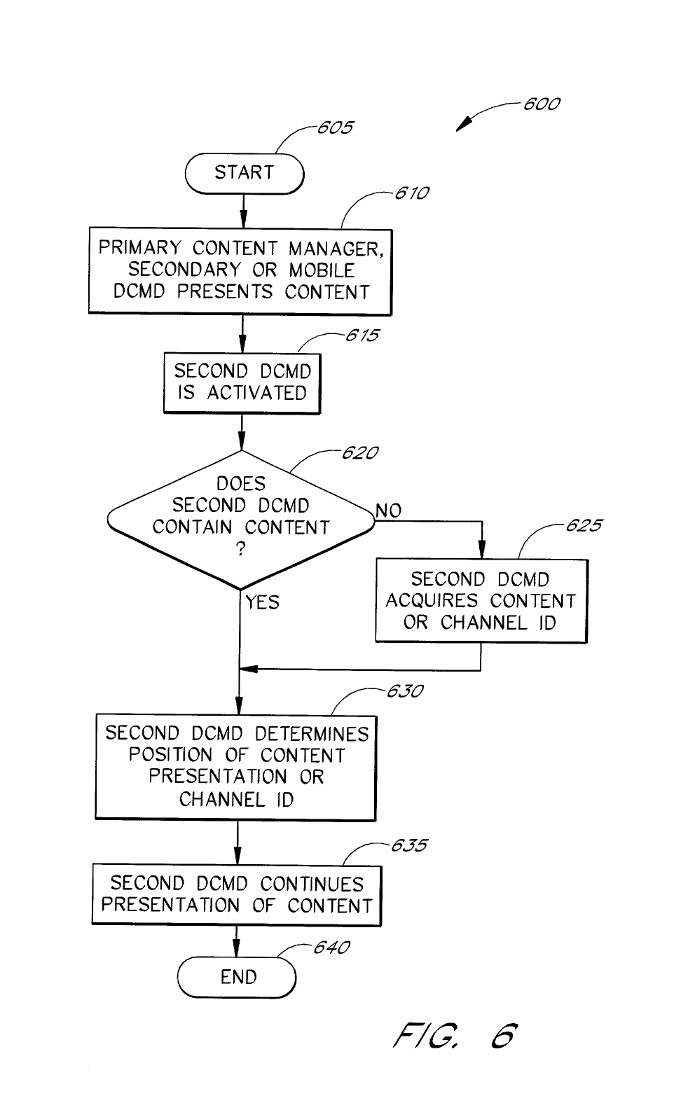

Based on the foregoing, one of the primary digital content manager, the secondary DCMD 105, or the mobile DCMD 110 may be presenting content to a user. As shown in FIG. 1 and according to one embodiment, as the user moves from, for example, his or her home to his or her automobile, the user may advantageously trigger an event causing the content being presented on, for example, the secondary DCMD 105, to continue to be presented on, for example, the mobile DCMD 110. According to one embodiment, the event may include activating the mobile DCMD 110, deactivating the secondary DCMD 105, selecting an option on the mobile DCMD 110, the secondary DCMD 105, or any other device or combination of devices, or combinations of the foregoing. The foregoing content continuation is described in more detail below with reference to FIG. 6.

As shown in FIG. 1, the primary content manager 100 includes the content synchronization module 120. In one embodiment, the content synchronization module 120 operates to synchronize content between one or more DCMDs. In one embodiment, the content synchronization module 120 advantageously operates to automatically synchronize content between one or more DCMDs when the one or more DCMDs are within close proximity of each other. A skilled artisan will recognize from the disclosure herein that device synchronization may be performed in a variety of ways, including automatic synchronization. A skilled artisan will recognize that automatic synchronization may be performed using one of several communication protocols, such as, for example, IEEE (Institute of Electrical & Electronics Engineers) 802.11 standard, as is well known in the art and is incorporated herein by reference. In one embodiment of the invention, when the DCMD commences operation, such as during power-up, the DCMD polls for signals from other devices, such as other DCMDs, within transmission range. If the DCMD receives a transmission during polling, the DCMD synchronizes with the source of the transmission using a communication protocol as is well known in the art.

As illustrated in FIG. 1, the primary content manager 100 can be located in any facility such as, for example, a house, an apartment, a commercial facility, or the like. The secondary DCMD 105 can be located in any facility such as, for example, a house, an apartment, a commercial facility, or the like. The mobile DCMD 110 can be located in any mobile vehicle such as, for example, an automobile, a ship, an airplane, or the like. Further, the mobile DCMD 110 can be carried on a person. The primary content manager 100, the secondary DCMD 105, and the mobile DCMD 110 advantageously communicate with each other using the communication device 125.

In one embodiment of the invention, the primary content manager 100, the secondary DCMD 105, and the mobile DCMD 110 advantageously communicate with each other using wireless transmissions through the communication device 125. A skilled artisan will recognize that the wireless transmissions disclosed herein may be performed using any transmission or wireless protocol, such as, for example, the IEEE 802.11 standard (incorporated herein by reference) for wireless transmissions, or the like. According to another embodiment, the transmissions disclosed herein may be performed by any communication protocol, such as, for example, the Bluetooth communications protocol, or the like.

According to one embodiment, the primary content manager 100 advantageously provides content to the secondary DCMD 105 and the mobile DCMD 110. The content may include a variety of digital objects. In one embodiment of the invention, the content includes digital music files, e-mails, voice mails, digital movies, news clips, weather reports, stock prices, and the like. In one embodiment, the primary content manager 100 operates to receive and transmit content. In one embodiment of the invention, the secondary DCMD 105 operates to receive and transmit content. In one embodiment of the invention, the mobile DCMD 110 operates to receive and transmit content.

FIG. 2 illustrates a block diagram of a DCMD 205 of FIG. 1 according to aspects of an embodiment of the invention. According to one embodiment, the DCMD 205 comprises a firmware memory 210, a memory 215, a mass storage device 220, a processing unit 225, a bus controller 230, a wireless chipset 235, a decompression/amplification unit 240, a communication device 245, and an output device 250. In one embodiment of the invention, the DCMD 205 is connected to a power conditioning and back up unit 255. In one embodiment of the invention, the DCMD 205 is connected to an interface bus 260. Also, as illustrated in FIG. 2, the DCMD 205 advantageously connects to functional modules 265 through the interface bus 260.

The DCMD 205 includes the firmware memory 210. According to one embodiment of the invention, the firmware memory 210 includes any memory used when initiating a computing device, such as, for example, Read-Only Memory (ROM), and the like. The DCMD 205 includes the memory 215. According to one embodiment of the invention, the memory 215 comprises any memory device used to store information while the computing device is in operation, such as, for example, Dynamic Random Access Memory (DRAM), Random Access Memory (RAM) and the like. In one embodiment of the invention, the memory 215 comprises non-volatile or solid-state memory, such as, for example, a Flash memory device, or the like. The DCMD 205 includes the mass storage device 220. According to one embodiment of the invention, the mass storage device 220 is any device capable of storing data, such as, for example, a hard disk drive, plug and play type memories, removable magnetic or optical disks, or the like. In one embodiment of the invention, the mass storage device 220 comprises non-volatile or solid-state memory, such as, for example, a Flash memory device, or the like.

As illustrated in FIG. 2, the DCMD 205 includes the processing unit 225. According to one embodiment of the invention, the processing unit 225 comprises a microprocessor, such as, for example, an Intel-based processor or a Motorola-based processor, or the like. The DCMD 225 includes a bus controller 230. In one embodiment of the invention, the bus controller 230 is any device through which data is transferred between two devices, such as, for example, a Universal Serial Bus (USB) controller chipset, or the like.

The DCMD 205 includes the wireless chipset 235. In one embodiment of the invention, the wireless chipset 235 is any computing device capable of transferring digital information through wireless transmission, such as, for example, wireless chipsets commercially available from Lucent, Proxim, and the like. The wireless chipset 235 is advantageously connected to the communication device 245 and operates to transmit digital data. In one embodiment of the invention, the wireless chipset 235 and the communication device 245 advantageously receive and transmit digital information. The DCMD 205 includes decompression and amplification modules 240. As will be recognized by a skilled artisan from the disclosure herein, the decompression module may advantageously employ software, hardware, or a combination thereof, to decode or decompress data before passing the data to the amplification unit. The amplification unit may advantageously amplify the signal. In one embodiment of the invention, the decompression and amplification modules 240 may include any device capable of modifying or altering digital data in preparation for outputting a signal to an output device 250. In one embodiment of the invention, the output device 250 includes any device capable of outputting digital signals from the DCMD 205, such as, for example, a audio speaker, a display screen, or the like.

In one embodiment of the invention, the DCMD 205 is advantageously connected to the power conditioning and back up unit 255. The power conditioning and back up unit 255 comprises any power source, such as, for example, a car battery, an alkaline battery, or the like. As illustrated in FIG. 2, the DCMD 205 advantageously connects to the functional modules 265 through the interface bus 260. In one embodiment of the invention, the interface bus 260 includes any device capable of facilitating the transfer of data, such as, for example, a computer data bus or the like. In one embodiment of the invention, the interface bus 260 is any device through which data is transferred between two or more devices, such as, for example, a Universal Serial Bus (USB) controller chipset, a Firewire (IEEE 1394), or the like.

Although the DCMD 205 is disclosed with reference to the foregoing embodiments, the invention is not intended to be limited thereby. Rather, a skilled artisan will recognize from the disclosure herein that the DCMD 205 may advantageously comprise one or more computing devices capable of conducting the activities described herein with reference to the DCMD 205. For example, the DCMD 205 may comprise a single wireless chipset or multiple wireless chipsets. Furthermore, in other embodiments, the DCMD 205 may not include all of the components disclosed herein. For example, the DCMD 205 may operate without the use of the mass storage device 220, as an example, or other components described herein. Furthermore, the DCMD 205 may reside on one or more housing components, such as computer motherboards, or the like. Further, the DCMD 205 may function without any additional functional modules 265 or with some of the additional functional modules 265 disclosed herein.

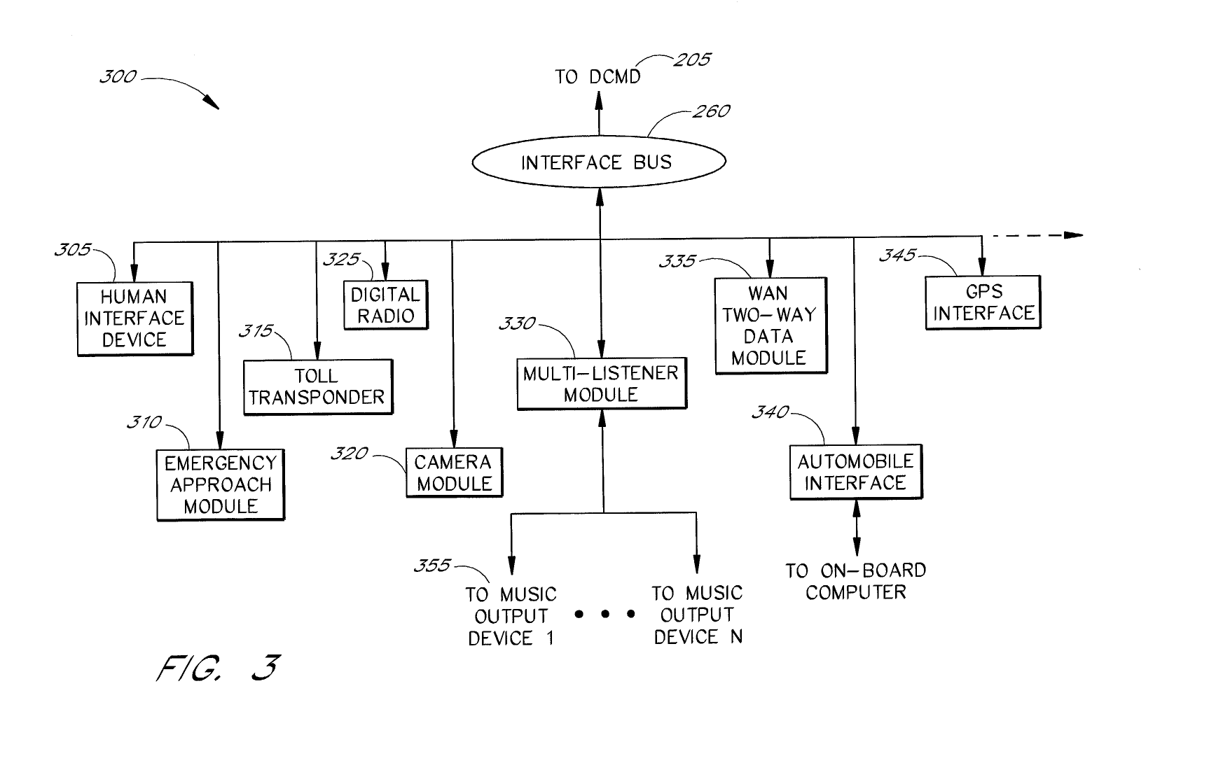

FIG. 3 illustrates a block diagram of various functional modules adaptable for use with the DCMD 205 of FIG. 2, according to aspects of an embodiment of the invention. According to one embodiment of the invention, the various functional modules adaptable for use with the DCMD of FIG. 2 includes a human interface device 305, an emergency approach module 310, a toll transponder 315, a camera module 320, a digital radio 325, a multi-listener module 330, a wide area network (WAN) two-way data module 335, an automobile interface module 340, and a global positioning system (GPS) interface module 345. As illustrated in FIG. 3, in one embodiment of the invention, the various functional modules advantageously interact with the DCMD 205 through the interface bus 260. The interface bus 260 is as disclosed herein with reference to FIG. 2.

In one embodiment of the invention, the human interface device 305 includes any device capable of facilitating an interaction between humans and computing devices, such as, for example, a touch-screen device, a keyboard, a mouse, a speaker, and the like, or a combination of any such device, such as a keyboard with a touch-screen area. In one embodiment of the invention, the human interface device 305 includes any computer input device. Thus, a user of the invention can send commands to the DCMD 205 by using the human interface device 305. Furthermore, the DCMD 205 responds to user command through output through the human interface device 305. For example, a user can use the human interface device 305 to request digital music files to be played. The DCMD 205 then plays the digital music files using the human interface device 305.

In one embodiment of the invention, the emergency approach module 310 includes any device capable of warning a driver or passengers of the motor vehicle of proximity to an emergency vehicle. In one embodiment of the invention, the emergency approach module 310 advantageously warns the occupants of a motor vehicle of an approaching emergency vehicle, such as an ambulance, a fire truck, a police car, or the like. In one embodiment of the invention, the emergency approach module 310 is advantageously connected to the DCMD 205, and thus, the emergency approach module 310 is capable of affecting the operation of the DCMD 205 in order to warn the occupants of the motor vehicle. For example, the emergency approach module 310 can warn the occupants through the DCMD 205 by lowering the music level output in the motor vehicle in order to allow the occupants to take notice of an approaching emergency vehicle. In another embodiment of the invention, the emergency approach module 310 is advantageously connected to the DCMD 205 and thus, the emergency approach module 310 is capable of transmitting a visual or auditory warning to the occupants of the motor vehicle, through the DCMD 205, in order to allow the occupants to take notice of an approaching emergency vehicle.

In one embodiment of the invention, the various functional modules include a toll transponder 315. In one embodiment of the invention, the toll transponder 315 includes any device capable of interacting with toll devices on toll highways. The toll transponder 315 interacts with the toll system of a highway to facilitate the passage of a motor vehicle while accounting for a toll payment. For example, using the toll transponder 315, the driver of a motor vehicle can pass through a toll area without stopping, while the driver's toll account is accordingly debited with the amount of the toll.

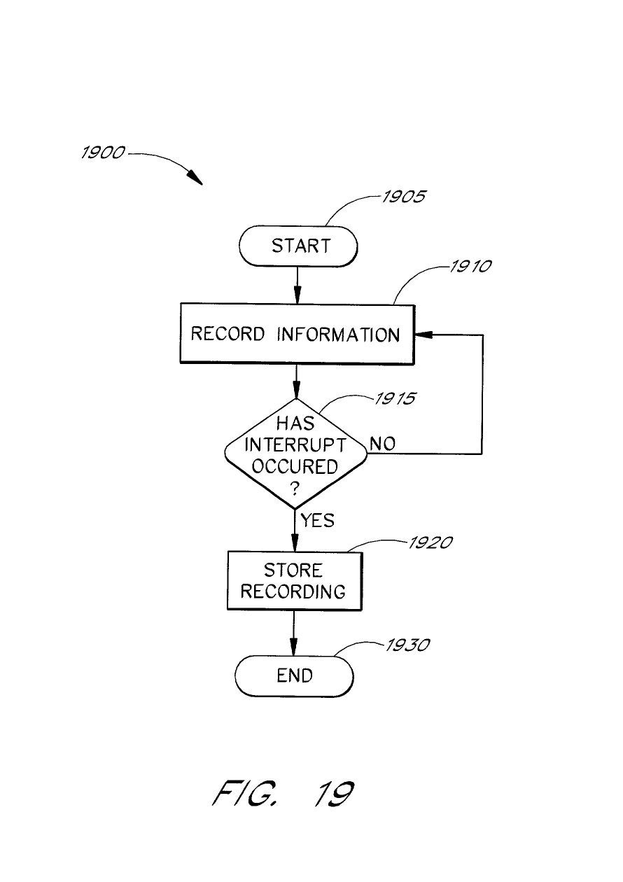

According to one embodiment of the invention, the various functional modules include a camera module 320. In one embodiment of the invention, the camera module 320 includes any device capable of recording visual information, such as, for example, a camera, or the like. In one embodiment of the invention, the camera module 320 advantageously functions to record the surroundings of a motor vehicle. In another embodiment of the invention, the camera module 320 advantageously records information on a first in first out (FIFO) basis. Therefore, the camera module 320 advantageously operates to record the surroundings of a motor vehicle for certain amount of time preceding the stoppage of recording. The camera module 320 is further disclosed with respect to FIG. 19.

In one embodiment of the invention, the various functional modules include the digital radio 325. In one embodiment of the invention, the digital radio 325 includes any device capable of receiving digital radio transmissions, such as, for example, a digital radio, or the like. In one embodiment of the invention, the various functional modules include a multi-listener module 330. In one embodiment of the invention, the multi-listener module 330 is any device capable of outputting digital signals to one or more output devices, preferably providing the ability for each output device to present differing or the same content to each user. In one embodiment of the invention, multi-listener module 330 outputs content to one or more music output devices 355. In one embodiment of the invention, the music output device 335 includes any device capable of converting digital information into sound signals, such as, for example, a speaker system, or the like.

As illustrated in FIG. 3, the various functional modules include a wide area network (WAN) two-way data module 335. The WAN two-way data module 335 comprises any device capable of interfacing the DCMD 205 with a wide area network, such as a pager wide area network, mobile telephone network, satellite network, combinations thereof, or the like. Thus, the WAN two-way data module 335 advantageously operates to allow two-way transmission of data between the DCMD 205 and a wide area network.

As illustrated in FIG. 3, the various functional modules include the automobile interface 340. As illustrated in FIG. 3, the automobile interface 340 is advantageously connected to the onboard computer on a motor vehicle. In one embodiment of the invention, the automobile interface 340 comprises a device capable of interfacing between the DCMD 205 and the onboard computer of a motor vehicle. The automobile interface 340 advantageously facilitates to transmit data between the onboard computer of the motor vehicle and the DCMD 205. In this way, various information regarding the motor vehicle can be transmitted to the DCMD 205. For example, the operating parameters, fault codes, diagnostics, or the like, of the motor vehicle can be received from the onboard computer by the automobile interface 340 and that information is then sent to the DCMD 205. Therefore, the DCMD 205 advantageously is able to use the motor vehicle's information in the operation of the DCMD 205.

As illustrated in FIG. 3, the various functional modules include a global positioning system (GPS) interface 345. As illustrated in FIG. 3, the GPS interface 345 advantageously connects to the national GPS system available for personal, public, and commercial use, thereby providing the functionality of on-board directional mapping, position finding, acquisition of real-time driving directions, or the like, to the mobile DCMD.

Although the various functional modules are disclosed with reference to the foregoing embodiments, the invention is not intended to be limited thereby. Rather, a skilled artisan will recognize from the disclosure herein a wide number of alternative embodiments of the various functional modules including any device capable of interfacing with the DCMD 205.

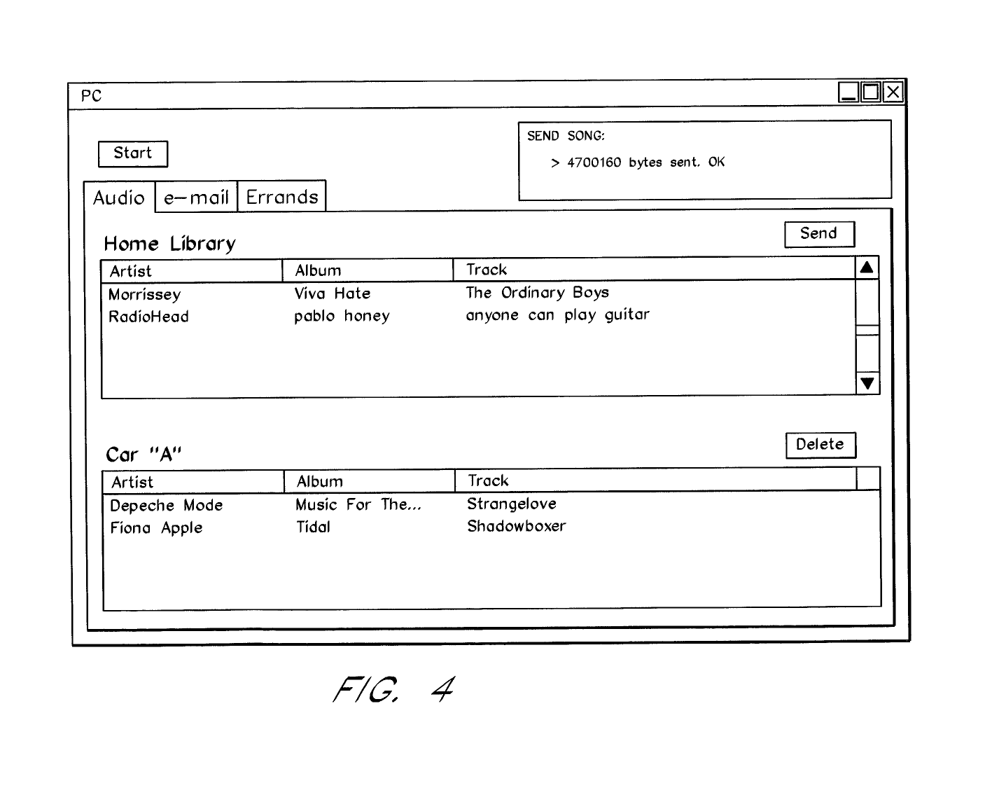

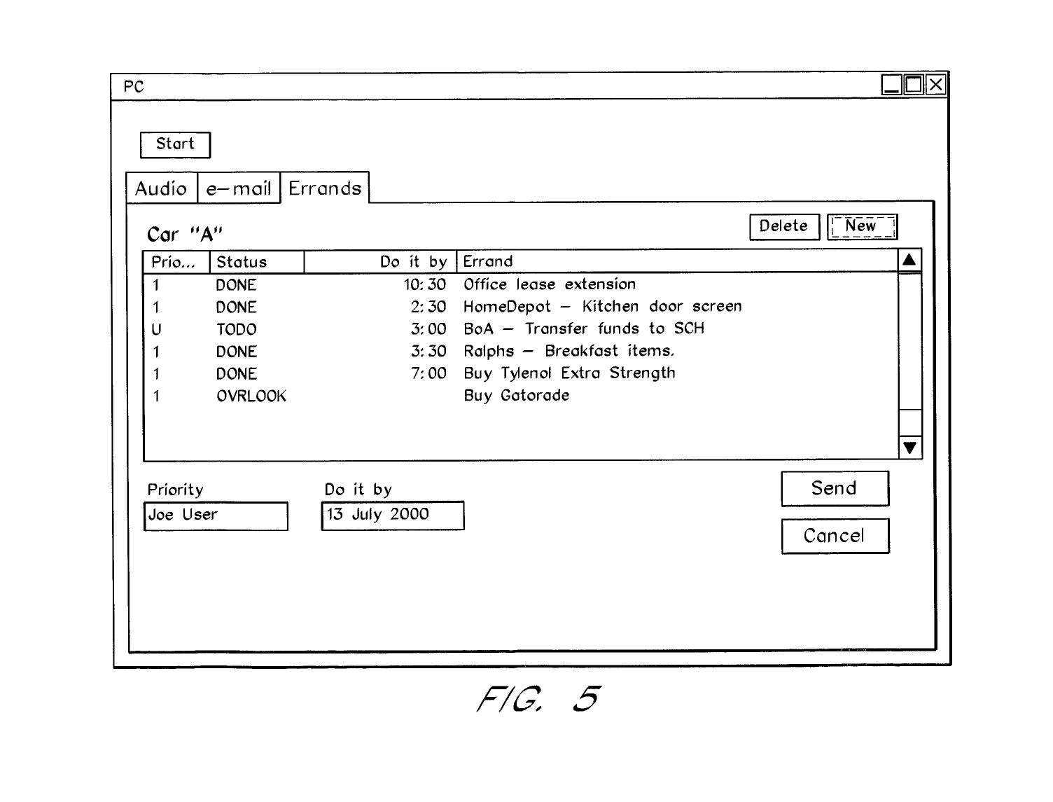

FIGS. 4 and 5 illustrate screen displays of the content synchronization program of the management device of FIG. 1, according to aspects of an embodiment of the invention. As illustrated in FIGS. 4 and 5, content, such as, for example, music files, errand lists, email or the like can be synchronized across multiple devices. For example, FIGS. 4 and 5 illustrate content being synchronized, through known drag and drop windowing techniques using software executing on the primary content manager 100, between the manager 100 and the mobile DCMD 110, labeled “Car A.”

A skilled artisan will recognize from the disclosure herein that a large number of different content may advantageously be synchronized between one or all of the devices within a given DCMS. For example, the mobile DCMD 110 may advantageously acquire new content from, for example, one or more businesses. That content may then be synchronized to one or more other mobile DCMDs, one or more other primary or secondary DCMDs, or any combination of the foregoing. In addition, a skilled artisan will recognize from the disclosure herein that the foregoing synchronization may advantageously be automated. For example, when one device comes into proximity to another device, such as, for example, when the mobile DCMD 100 comes within transmission range of one of the primary or secondary DCMDs, the exchange of data may be automatic. Moreover, according to one embodiment, each device may individually, severally, or as a group, be programmed to automatically synchronize all or some of their content, or all or some of certain types of data, such as, for example, email and music.

Based on the foregoing, the DCMS advantageously provides users the ability to efficiently and effectively manage and synchronize content between devices.

FIG. 6 illustrates a flow chart of a content continuation process 600 according to aspects of an embodiment of the invention. In one embodiment of the invention, the content continuation process 600 starts at Step 605. At Step 610, a primary content manager 100, a secondary DCMD 105, or a mobile DCMD 110 is presenting content, and the content continuation process 600 proceeds to Step 615. At Step 615, a second DCMD, such as one of the primary content manager 100, a secondary DCMD 105, or a mobile DCMD 110, is activated, and the content continuation process 600 proceeds to Step 620. At Step 620, the second DCMD determines if the second DCMD contains the content or has the content channel ID associated with the content being presented on the original DCMD. At Step 620, if the second DCMD does not contain the content presented or the content channel ID, the content continuation process 600 proceeds to Step 625. At Step 620, if the second DCMD does contain the content presented or the content channel ID, the content continuation process 600 proceeds to Step 630. At Step 625, the second DCMD acquires content from the originally presenting DCMD of Step 610, or obtains the content channel ID from the same. At Step 630, if the second DCMD received content, the second DCMD may advantageously determine a position of the content presentation or the channel ID.

According to one embodiment, the second DCMD determines the position of the content presentation by receiving an indication or indicator of the same from the originally presenting DCMD of Step 610. The position may advantageously be near the time of activation of the second DCMD, deactivation of the originally presenting DCMD, or the like. Additionally, a skilled artisan will recognize from the disclosure herein that both the originally presenting DCMD and the second DCMD may continue to present the content from or near the position indication. Moreover, the foregoing content continuation may spread over more that two devices.

At Step 635, if the second DCMD received content, the second DCMD may advantageously continue the presentation of the content using, for example, a position near the transmitted position. For example, the second DCMD may advantageously replay the most recent portion of the content to ensure such portion had been presented to the user. Moreover, the user may advantageously actuate controls on the second DCMD to adjust the position of the presentation of the content to his or her preferred location.

Alternatively, at Step 635, if the second DCMD received a channel ID, the second DCMD may advantageously continue the presentation of the content by using the content channel ID, such as, for example, automatically tuning into a radio channel, other broadcast content, or the like.

Thus, based on the foregoing, the content continuation process 600 advantageously provides the user with the ability to listen to, for example, an email being presented on, for example, the secondary DCMD 105, walk outside to his or her automobile, and continue the presentation of the email there. Thus, content important to the user, or even just the radio, need not be missed simply because the user changes locations.

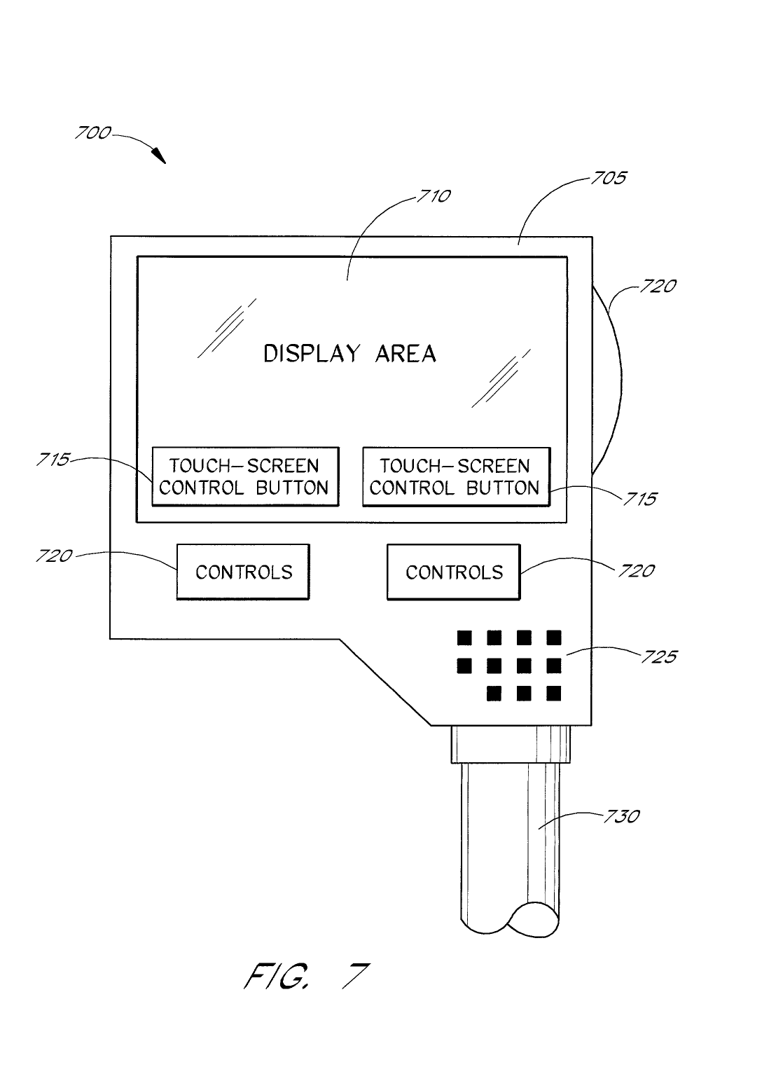

FIG. 7 illustrates a simplified view of a human interface device 700 of a DCMD of FIG. 1 according to aspects of an embodiment of the invention. As illustrated in FIG. 7, the human interface device 700 includes a housing 705, a display area 710, one or more touch-screen control buttons 715, one or more controls 720, a sound interface unit 725, and an interface unit 730. In one embodiment of the invention, the housing 705 contains the various components of the human interface device 700. In one embodiment of the invention, the display area 710 comprise any device capable of displaying information, such as, for example, a liquid crystal display (LCD) or the like. In one embodiment of the invention, the touch-screen control button 715 comprise any device capable of translating pressure on the display area 710 into digital signals, such as, for example, computer commands.

As illustrated in FIG. 7, the human interface device 700 includes one or more controls 720. In one embodiment of the invention, the controls 720 comprise any device capable of transmitting commands to the human interface device 700. In one embodiment of the invention, the controls 720 includes buttons, scroll wheels, voice activated buttons, and the like. As illustrated in FIG. 7, the human interface device 700 includes a sound interface device 725. In one embodiment of the invention, the sound interface device 725 includes any device capable of transmitting sound, such as, for example, a speaker, or any device capable of receiving sound, such as, for example, a microphone, or the like. In one embodiment of the invention, the human interface device 700 may include one or more sound interface devices 725. For example, the human interface device 700 may comprise of one or more speakers and one or more microphones. In one embodiment of the invention, the interface device 730 comprises any device capable of transferring digital information between the human interface device 700 and the DCMD 205, such as, for example, a computer cable, a telephone cable, or the like. In one embodiment of the invention, the interface device 730 comprises any device capable of wirelessly transferring digital information between the human interface device 700 and the DCMD 205, such as, for example, a device using Bluetooth protocol, IEEE 802.11 protocol, or the like. In one embodiment of the invention, the interface device 730 advantageously connects the human interface device 700 with the DCMD 205.

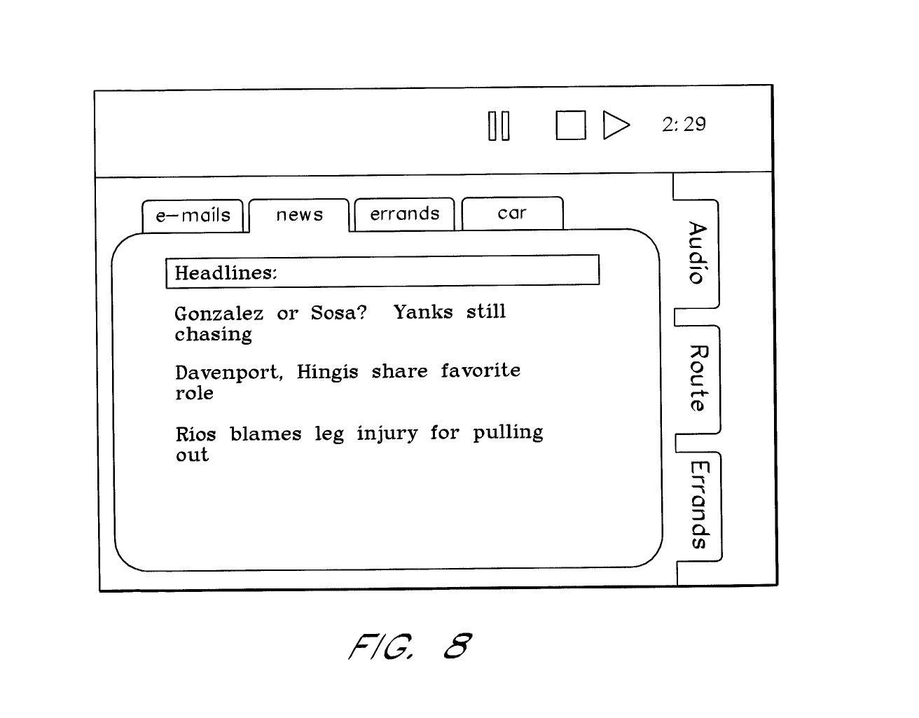

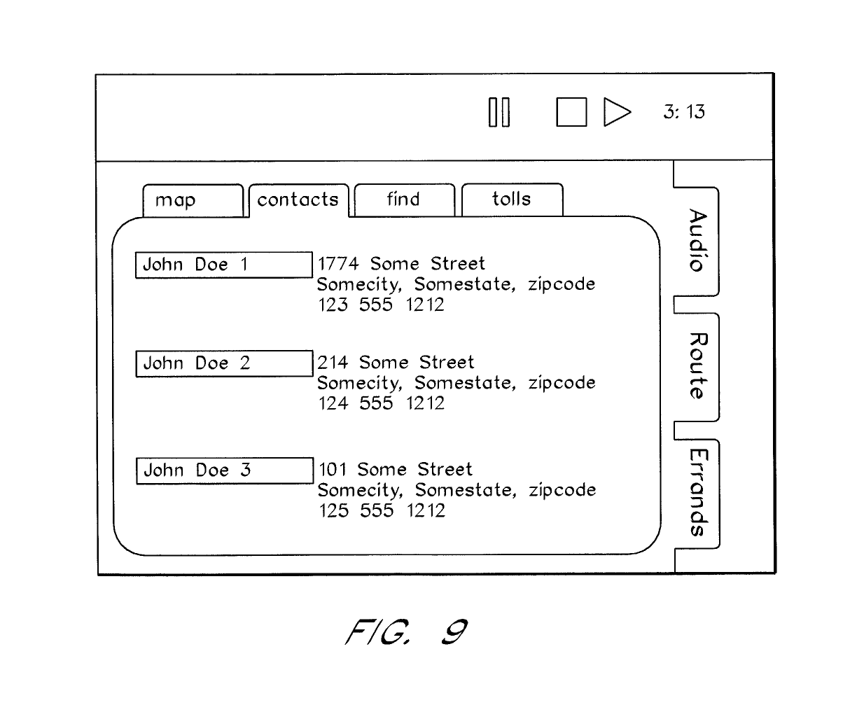

FIGS. 8 and 9 illustrate screen displays of the human interface device 700 of FIG. 7 according to aspects of an embodiment of the invention. As shown in FIGS. 8 and 9, the human interface device 700 may advantageously communicate with the mobile DCMD 110 to display content, such as, for example, news, e-mails, digital movies, news clips, weather reports, stock reports, contact information, calendar, phone list, or the like.

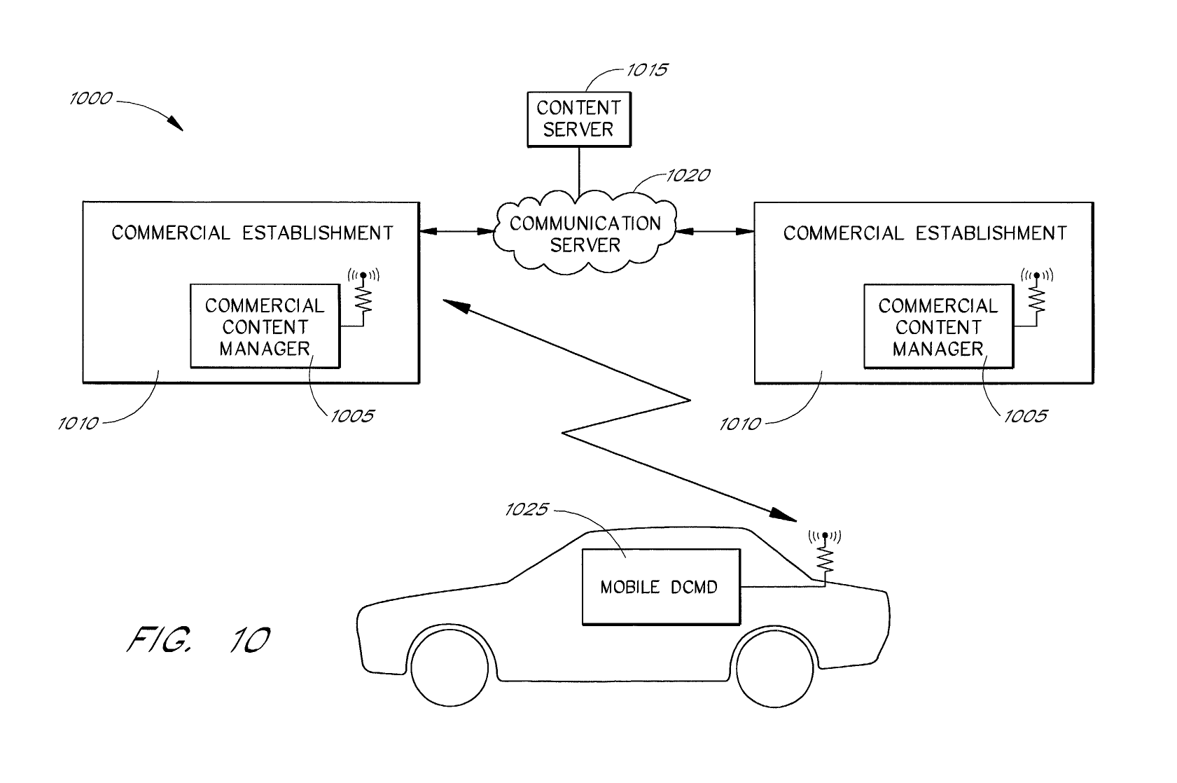

FIG. 10 illustrates a block diagram of a commercial wireless transmission system 1000, according to aspects of an embodiment of the invention. As illustrated in FIG. 10, the commercial wireless transmission system 1000 includes a commercial content manager 1005. In another embodiment of the invention, the commercial wireless transmission system includes the commercial content manager 1005, a communication network 1020, and a content server 1015. In one embodiment of the invention, the content server 1015 is advantageously connected to one or more commercial content managers 1005 through the communication network 1020. In one embodiment of the invention, the communication network 1020 comprises a computer network, such as, for example, a wide area network, a local area network, a wireless network, the Internet, or the like. As illustrated in FIG. 10, in one embodiment of the invention, the commercial content manager 1005 resides in a commercial establishment 1010. In another embodiment of the invention, the commercial content manager 1005 resides outside the commercial establishment 1010.

In one embodiment of the invention, the content server 1015 comprises a computer server system including the ability to wirelessly broadcast and receive content to and from, from example, the mobile DCMD 110. The content server 1015 advantageously distributes commercial content to one or more commercial content managers 1005. According to one embodiment, the commercial content may advantageously comprise location-based advertising, such as data or presentations associated with sales and marketing activities of the commercial establishment 1010. For example, if the commercial establishment 1010 is a gas station, the commercial content may include information about gas prices, car service promotions, discounts on car washes, or promotions involving related or unrelated third-party goods or services. For example, the commercial content may promote products by a third-party food provider operating within the gas station, or by another commercial establishment outside the gas station.

As illustrated in FIG. 10, the commercial content manager 1005 transmits to the mobile DCMD 110 residing on a motor vehicle. Further, as illustrated in FIG. 10, the commercial content manager 1005 receives transmissions from the mobile DCMD 110 residing on a motor vehicle. Thus, the commercial content manager 1005 accomplishes location-based advertising, marketing, and according to some embodiments, electronic commerce, by promoting products and services to consumers driving in the proximity of the commercial content manager 1005.

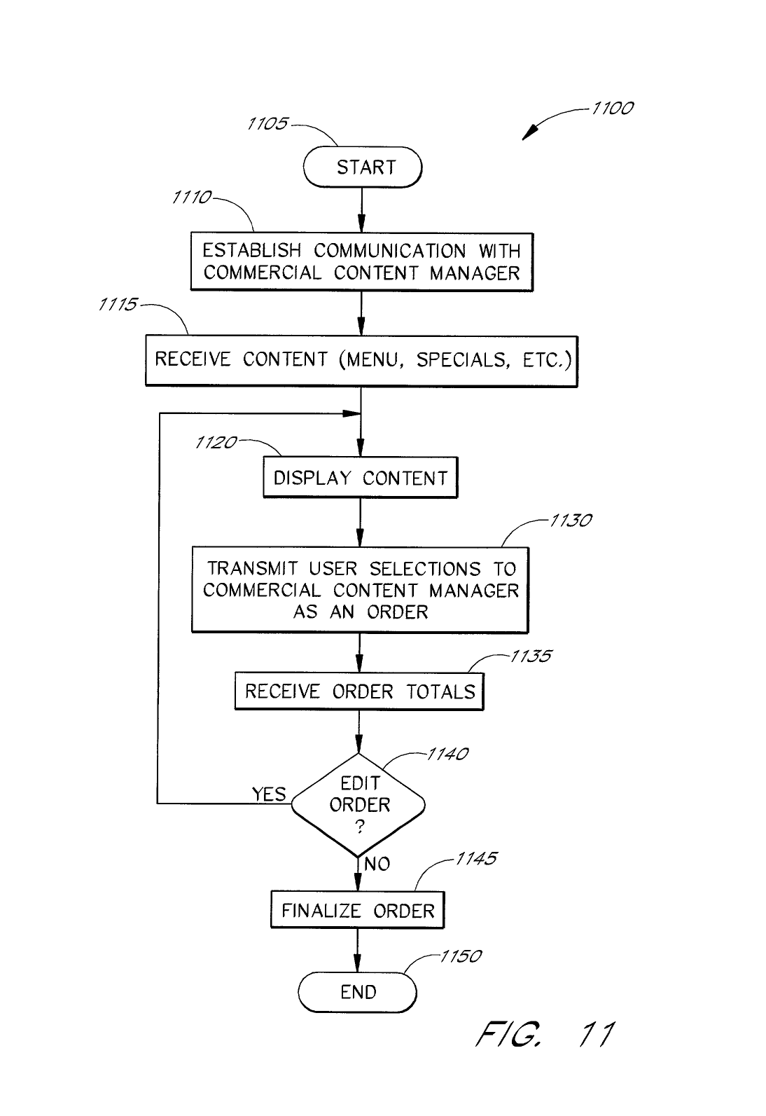

FIG. 11 illustrates a flow chart of a wireless drive-through process 1100, according to aspects of an embodiment of the invention. As illustrated in FIG. 11, wireless drive-through process 1100 starts at Step 1105. At Step 1110, the commercial content manager establishes communication with a mobile DCMD. According to one embodiment, the commercial content manager establishes communication with a mobile DCMD using any of the communication or synchronization technologies described herein. At Step 1115, the mobile DCMD receives content, such as, for example, a menu, specials, pricing, or virtually any content related to any goods or services, preferably offered by the commercial establishment 1010. At Step 1120, content is displayed to a consumer, and the wireless drive-through process 1100 proceeds to Step 1130. A skilled artisan will recognize from the disclosure herein that the content may be displayed in a variety of ways. For example, the content may be displayed on a human interface device, such as, for example, the device disclosed with reference to FIG. 7.

At Step 1130, the user transmits user selections to commercial content manager as an order, and the wireless drive-through process 1100 proceeds to Step 1135. In one embodiment of the invention, the user transmits user selections using the human interface device. In another embodiment of the invention, user transmits user selections using the sound input device on the human interface device, or any other sound input device. At Step 1135, the commercial content manager receives order totals from the mobile DCMD, and the wireless drive-through process 1100 proceeds to Step 1140. At Step 1140, if the mobile DCMD transmits a request to edit orders, the wireless drive-through process 1100 proceeds to Step 1120. If, at Step 1140, there are no further desired edits to the order, the wireless drive-through process 1100 proceeds to Step 1145. At Step 1145, the commercial content manager finalizes the order. In one embodiment of the invention, the order is finalized when the user makes a payment to the commercial establishment. A skilled artisan will recognize from the disclosure herein that the payment may take a variety of forms. For example, payment may include paying cash to the commercial establishment, transmitting credit or debit card information to the commercial establishment, for example, by using the mobile DCMD, or by using any electronic payment system, such as, for example, an electronic purse employed by the mobile DCMD. After Step 1145, the wireless drive-through process 1100 proceeds to Step 1150. At Step 1150, the wireless drive through process 1100 ends.

In one embodiment of the invention, the consumer may wirelessly obtain at least a portion of the funds for the payment from a banking device. The banking device may include an automated teller machine (ATM). In one embodiment on the invention, when the mobile DCMD is within proximity of an ATM, the mobile DCMD and the ATM automatically synchronize with each other. A skilled artisan will recognize that synchronization with the ATM may involve a variety of methods and may include methods of identification and security. In one embodiment of the invention, after the mobile DCMD and the ATM synchronize, the consumer may wirelessly transfer funds between the ATM machine and the mobile DCMD. For example, the consumer may replenish the electronic purse, or other digital currency, residing on the mobile DCMD. According to another embodiment, the mobile DCMD may replenish the electronic purse using, for example, an on-line connection to a service providing fund transfers. In such an embodiment, the on-line connection may occur at the primary content manager 100 and later synchronize the electronic purse content to the mobile DCMD, as discussed in the foregoing.

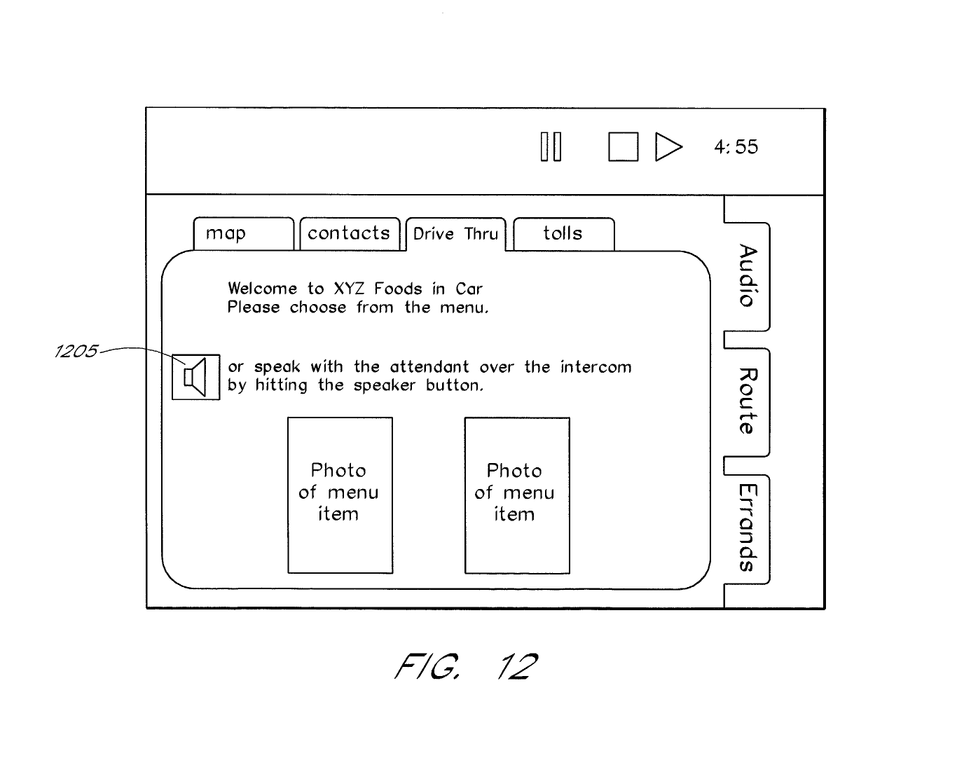

FIG. 12 illustrates a screen display of a human interface device communicating with the mobile DCMD of FIG. 10, according to aspects of an embodiment of the invention. As illustrated in FIG. 12, the screen display displays any information transmitted from the commercial content manager, such as menus, specials, pricing, and the like. A skilled artisan will recognize from the disclosure herein that the screen display may contain a variety of information and displays used in a drive-through process and may vary depending on the commercial enterprise interacting with the DCMD. For example, the menu and pricing transmitted by a pizza drive-through will likely differ from the menu and pricing transmitted by another pizza drive-through.

FIG. 12 also illustrates a microphone activation button 1205, according to aspects of an embodiment of the invention. In one embodiment of the invention, the user activates the microphone activation button 1205 in order to speak to an attendant of the drive-through. Once microphone activation button 1205 activated, the user interacts with the attendant through a sound input and output device, such as, for example, a microphone and a speaker, or the like.

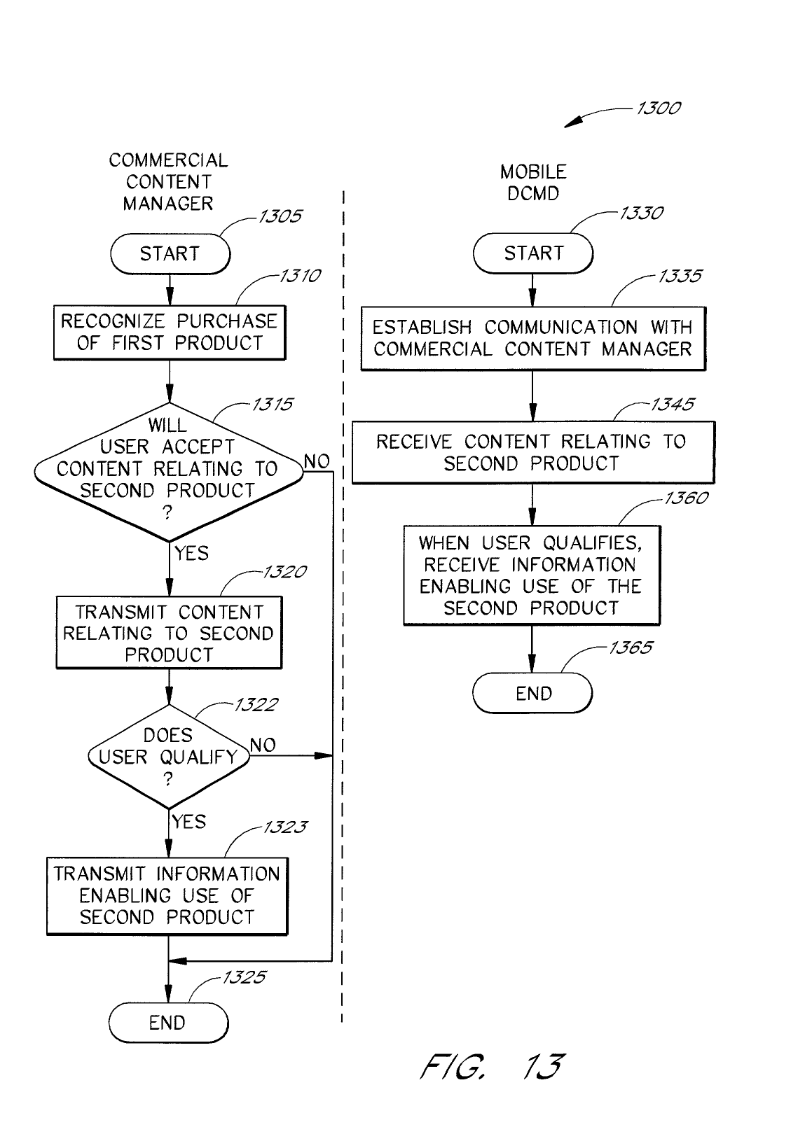

FIG. 13 illustrates a flow chart of a commercial cross-marketing process 1300, according to aspects of an embodiment of the invention. The commercial cross-marketing process 1300 for a commercial content manager starts at Step 1305. At Step 1310, the commercial content manager recognizes the purchase of a first product. The commercial cross-marketing process 1300 proceeds to Step 1315. At Step 1315, if the user will accept content relating to a second product, the commercial cross-marketing process 1300 proceeds to Step 1320. At Step 1315, if the user will not accept content relating to a second product, the commercial cross-marketing process 1300 ends. In one embodiment of the invention, the first product relates to the product of the commercial content manager and a second product relates to the product of a third party wishing to perform cross-marketing activities with the commercial content manager. In another embodiment of the invention, the first product and the second product both relate to the product of the commercial content manager.

At Step 1320, the commercial content manager transmits content relating to the second product, and the commercial cross-marketing process 1300 proceeds to Step 1322. At Step 1322, the commercial content manager determines if the user qualifies for the second product. If the user qualifies for the second product, the commercial cross-marketing process 1300 proceeds to Step 1323. According to one embodiment, when the user does not qualify for the second product, the commercial cross-marketing process 1300 ends. The user may qualify for the second product in various ways. In one embodiment of the invention, the commercial establishment may create the qualifications to receive the second product. For example, a gas station may require that users purchase a predetermined amount of gas before receiving the second content, such as, for example, a digital song or a digital video. When the user qualifies, at Step 1323, the commercial content manager transmits information enabling the use of the second product, and commercial cross-marketing process 1300 proceeds to Step 1325. In one embodiment, the information to enable the use of the second product comprises a digital key, a decryption code, a password, or any information capable of enabling the presentation of disabled content. At Step 1325, the commercial cross-marketing process 1300 for the commercial content manager ends.

The commercial cross-marketing process 1300 for the mobile data DCMD starts at Step 1330. At Step 1335, the mobile DCMD establishes communication with the commercial content manager. At Step 1345, the mobile DCMD receives content relating to the second product, and the commercial cross-marketing process 1300 proceeds to Step 1360. At Step 1360, if the user qualifies, the mobile DCMD receives information enabling the use of the second product, and the commercial cross-marketing process 1300 proceeds to Step 1365. At Step 1365, the commercial cross-marketing process 1300 for a mobile DCMD ends.

According to one embodiment, the commercial cross-marketing process 1300 may advantageously promote additional commerce opportunities for a user by creating a commerce loop. For example, when the mobile DCMD receives the content relating to the second product, at Step 1335, the user may not qualify for the product. In such case, the content may include instructions which allow for limited use of some or all of the content. Moreover, the content may include instructions on how the user can purchase the content. For example, using the DCMS of FIG. 1, the user may return to his or her home and the mobile DCMD may automatically synchronize or otherwise upload the content relating to the second product to, for example, the primary content manager 100, which in turn may automatically contact, for example, through the Internet, the source or reseller of the second product.

A skilled artisan will recognize from the disclosure herein that the foregoing example may be altered or expanded in a large number of commercially looping ways, including, payment for the second product through viewing advertisements through the mobile DCMD, electronic currency payments, manual synchronizations, employment of the secondary DCMD 105, or the like.

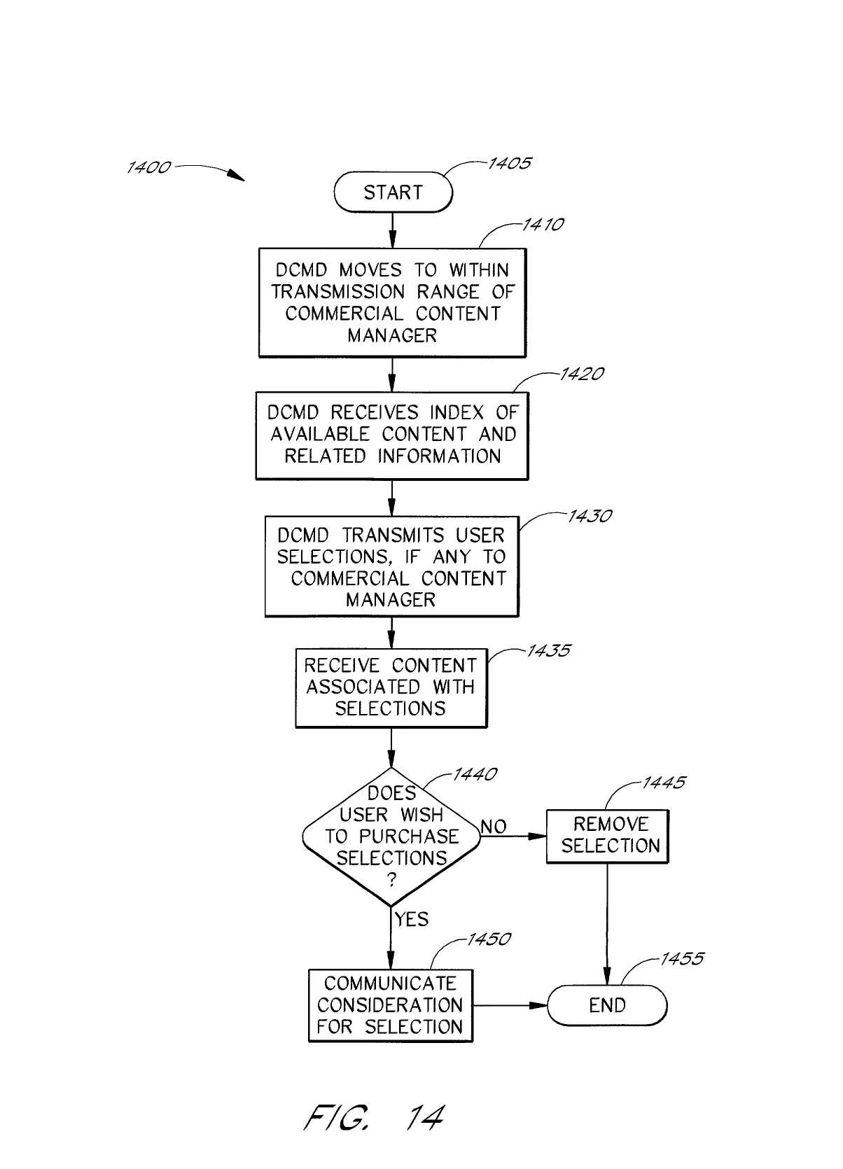

FIG. 14 illustrates a flowchart of a commercial content transmission process 1400, according to aspects of an embodiment of the invention. In one embodiment of the invention, the commercial content transmission process 1400 starts at Step 1405. At Step 1410, the DCMD 205 moves within transmission range of a commercial content manager. The commercial content manager may be used by any enterprise desiring to transmit content to the public in the transmission proximity of the commercial content manager. For example, a music store may wish to transmit music to consumers that drive to the music store. As another example, a video rental store may wish to transmit video clips of upcoming movies to consumers in the parking lot of the video rental store. After Step 1410, the commercial content transmission process 1400 moves to Step 1420. In one embodiment of the invention, the DCMD identifies itself to the commercial content manager and requests an index of content available from the commercial content manager. The DCMD 205 may identify itself through a variety of methods, such as, for example, an electronic ID card, or other means of uniquely identifying the DCMD 205, or through the consumer, or the like.

A skilled artisan will recognize that there are a variety of ways for a consumer to view the available content from a commercial enterprise. In one embodiment of the invention, a consumer enters the commercial establishment physically and is offered content. For example, a consumer can walk into a music store and view the songs or CDs available. Thus, the commercial content transmission process 1400 may involve a consumer who enters a store to view content, and the consumer selected content in then transmitted to the consumer's mobile DCMD. The consumer's mobile DCMD may be in a parked car within the store's transmission range, on the consumer's person, or in a variety of other locations.

As illustrated in FIG. 14, at Step 1420, the DCMD receives an index of available content and related information from the commercial content manager. The index comprises any information about the content available from the commercial content manager, such as, for example, a list of song, a list of videos, a list of CDs, or the like. The user of the DCMD 205 may browse available content and makes selections using the index received in Step 1420. For example, if the index is a list of CDs available for purchase, the user may select which CDs the user wishes to purchase. After Step 1420, the commercial content transmission process 1400 proceeds to Step 1430.

At Step 1430, if the user has made selections, the DCMD 205 transmits the selections to the commercial content manager, and the commercial content transmission process 1400 proceeds to Step 1435. At Step 1435, the mobile DCMD receives content associated with the selections, and the commercial content transmission process 1400 proceeds to Step 1440. At Step 1440, if the user does not wish to purchase the selections, the commercial content transmission process 1400 proceeds to Step 1445. At Step 1440, if the user wishes to purchase the selections, the commercial content transmission process 1400 proceeds to Step 1450. At Step 1445, the mobile content management device removes selections from the mobile content management device, and the commercial content transmission process 1400 proceeds to Step 1455. At Step 1450, the user communicates consideration for the selections. In one embodiment of the invention, the consideration is in the form of a payment. In one embodiment of the invention, the user advantageously makes payment through the DCMD 205. The user may make a payment through the DCMD 205 using several methods, such as, for example, an electronic purse or by transmitting a debit or credit card information. As another example, the user may also make payment in person or by other physical means. As yet another example, because the commercial content manager has identified the user, payment can take the form of a debit to the user's account with the enterprise using the commercial content manager. Once payment is made, or if the content does not require payment, the commercial content transmission process 1400 moves to Step 1455. At Step 1455, the commercial content transmission process 1400 ends.

According to one embodiment, the commercial content transmission process 1400 may include some or all of the commerce loop functionality disclosed with reference to FIG. 13. For example, at Step 1435, the selected content may advantageously include instructions for limited use. Thereafter, instructions may be synchronized with other devices such that the user is prompted, preferably automatically, to visit the source or a reseller of the content, such as an on-line website, to eventually purchase the same. Moreover, according to one embodiment, the commerce loop may include prompting and visitation of the website using the mobile DCMD and the WAN two way network, mobile or satellite phone network, or the like.

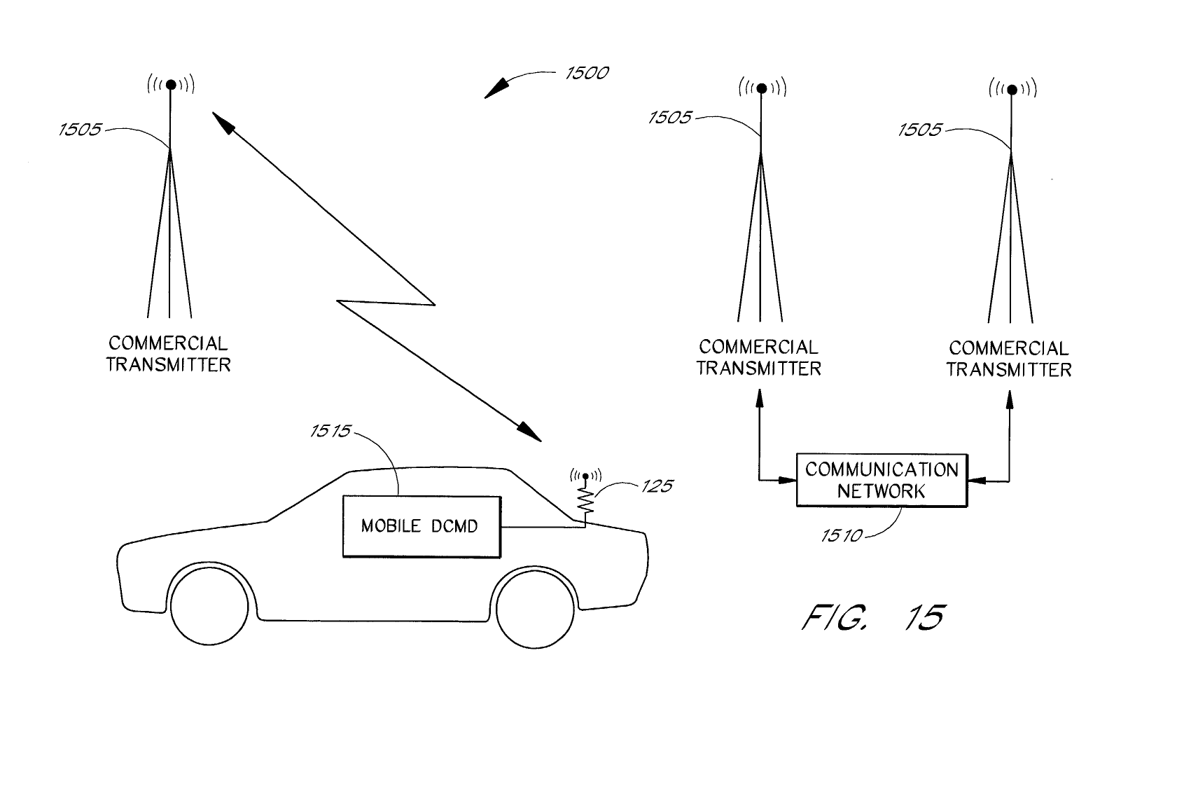

FIG. 15 illustrates a block diagram of another commercial wireless transmission system 1500, according to aspects of an embodiment of the invention. As illustrated in FIG. 15, the commercial transmitter 1505 may communicate with a mobile DCMD such that content may be presented on the DCMD. According to another embodiment, the commercial transmitter 1505 may establish communication with the mobile DCMD, including receiving communication from the mobile DCMD, such that other interaction opportunities advantageously are presented to the user.

In another embodiment of the invention, one or more commercial transmitters 1505 communicate to each other through a communication network 1510. For example, a large business may communicate localized information to one commercial transmitter 1505 but maintain central control thereof. According to this embodiment, the communication network 1510 comprises a computer network, such as, for example, a wide area network, a local area network, a wireless network, or the like. In another embodiment of the invention, one or more commercial transmitters 1505 communicate with each other through wireless transmissions.

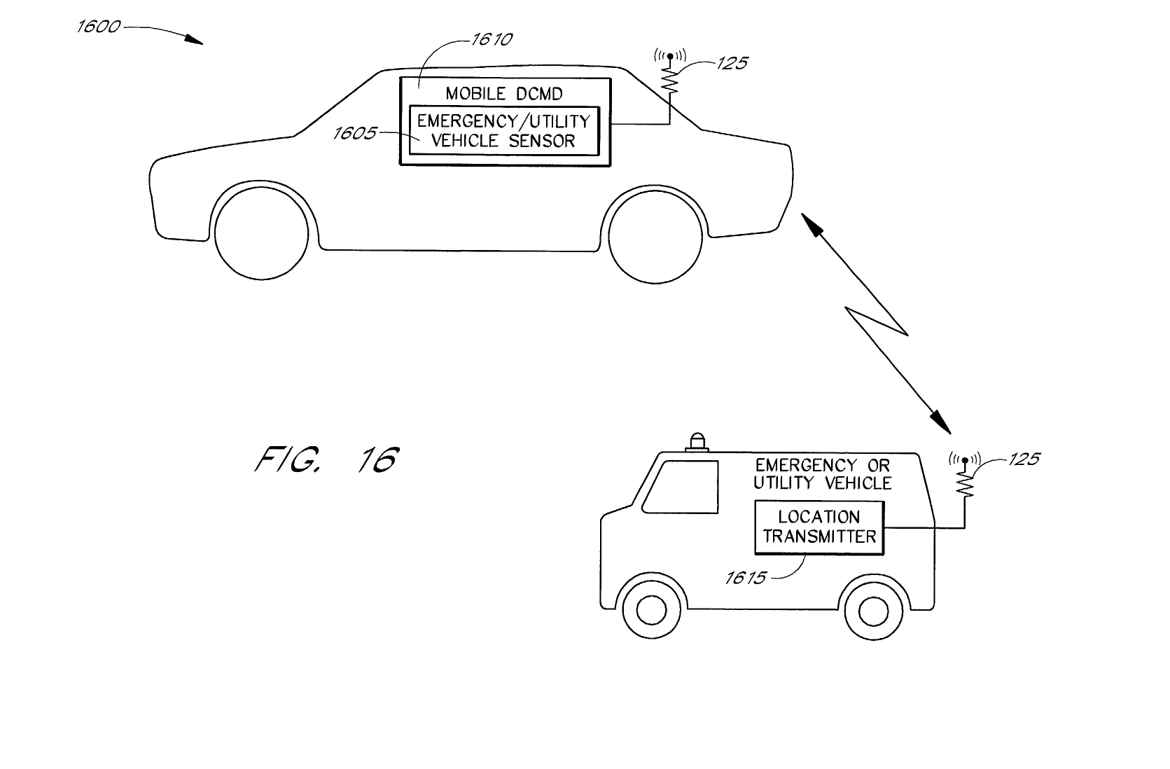

FIG. 16 illustrates a block diagram of a mobile DCMD having an emergency warning system, according to aspects of an embodiment of the invention. As illustrated in FIG. 16, in one embodiment of the invention, the mobile DCMD 110 comprises an emergency vehicle sensor module 1605. In one embodiment of the invention, the emergency vehicle sensor 1605 advantageously warns the user of a motor vehicle containing the mobile DCMD 110 in proximity to an emergency vehicle by receiving transmissions from, the emergency vehicle. For example, the emergency vehicle may be outfitted with a simple transmitter 1615 broadcasting a predetermined signal. According to one embodiment, the mobile DCMD may use the signal strength of such a transmitted signal to determine whether to alert the user of an approaching emergency vehicle. According to yet another embodiment, the emergency vehicle may transmit one or more GPS signals indicating coordinates of a current location of the emergency vehicle. The mobile DCMD may advantageously receive these coordinates and warn the user when the vehicle is within a predetermined distance. A skilled artisan will recognize from the disclosure herein that mapping functionality may also be used in the foregoing embodiment or that combinations of the foregoing embodiments may also be implemented. In one embodiment, the warning may take the form of reducing the volume of music output in the motor vehicle, a visual signal within the motor vehicle, GPS mapping, or the like.

In one embodiment of the invention, the emergency vehicle sensor module 1605 can distinguish between signals transmitted from a plurality of emergency vehicles. According to yet another embodiment, the mobile DCMD may include a sensor 1605 which detects stationary utility vehicles, traffic rerouting signs, lane closure signs, police alerts, or the like, thereby warning the user of approaching traffic issues. Moreover, the emergency or utility signal may be generated from a central station, such as a fire station, traffic watching center, police station, or the like, rather than, or in addition to, being mounted on the individual automobiles or traffic routing signs. According to yet another embodiment, the transmitter 1615 transmits additional information, such as, for example, the nature of the emergency or a specific message to the mobile DCMD 110. For example, messages regarding road construction, road closures, or accidents may be advantageously transmitted. Thus, the location transmitter 1615 advantageously warns other motor vehicles of the location of an emergency, a utility vehicle, or a road construction sign containing the location transmitter 1615.

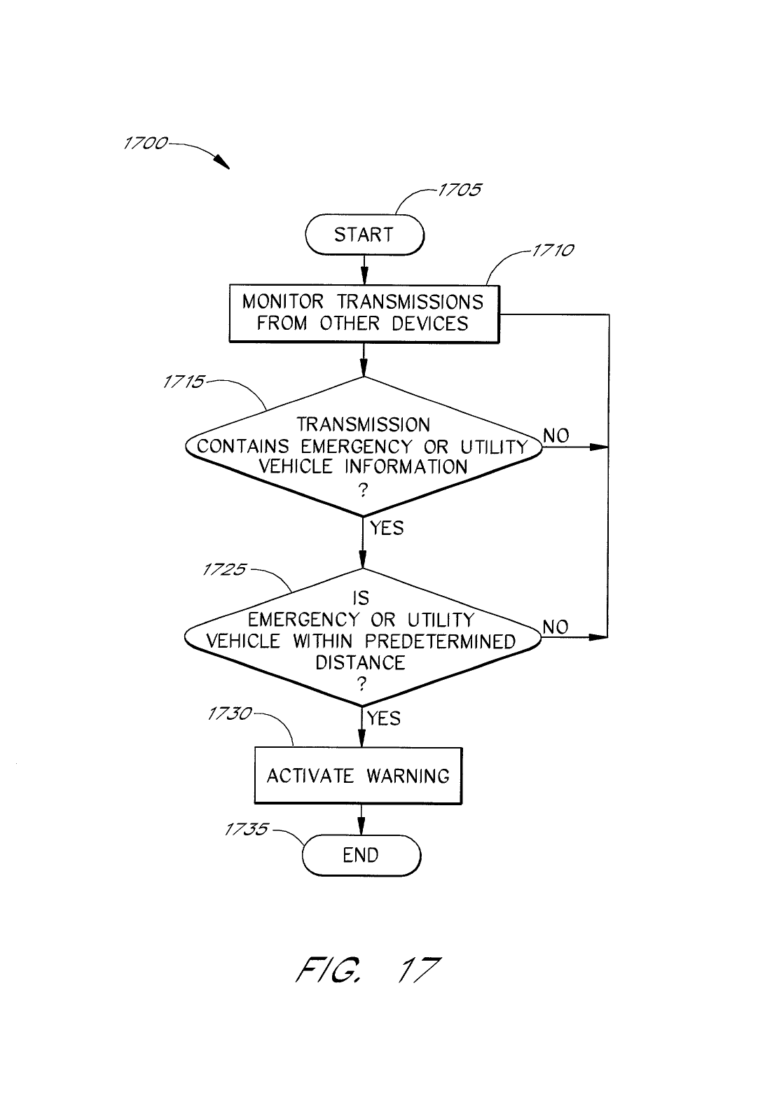

FIG. 17 illustrates a flowchart of an emergency or utility vehicle avoidance process 1700, according to aspects of an embodiment of the invention. In one embodiment of the invention, the emergency or utility vehicle avoidance process 1700 begins at Step 1705. At Step 1710, the DCMD monitors transmissions from other devices. After Step 1710, the emergency or utility vehicle avoidance process 1700 proceeds to Step 1715. At Step 1715, if a received transmission does not contain emergency or utility vehicle information, the emergency or utility vehicle avoidance process 1700 proceeds to Step 1710. If a received transmission does contain emergency or utility vehicle information, the emergency or utility vehicle avoidance process 1700 proceeds to Step 1725. In one embodiment of the invention, the DCMD uses the information in the transmission to analyze the locations of the DCMD and the emergency or utility vehicle. Therefore, using the information in the transmission from the emergency or utility vehicle, and the location of the DCMD, the DCMD determines if the path of the emergency vehicle is likely to come in proximity to the path of the motor vehicle containing the DCMD.

At Step 1725, if the DCMD determines that the motor vehicle and the emergency or utility vehicle are not within predetermined distance, the emergency or utility vehicle avoidance process 1700 proceeds to Step 1710. If, at Step 1725, the DCMD determines that the motor vehicle and the emergency or utility vehicle are within a pre-determined distance, the emergency or utility vehicle avoidance process 1700 proceeds to Step 1730. At Step 1730, the DCMD activates a warning for the occupants of the motor vehicle carrying the DCMD. The DCMD may warn the occupants using various methods. Several of the methods have been disclosed herein. For example, the DCMD may lower the volume of the motor vehicle's stereo system to allow the occupants to take notice of the approaching emergency vehicle. As another example, the DCMD may produce visual or auditory warning signals in the motor vehicle, such as, for example, a flashing light, an alarm siren, or the like. After Step 1730, the emergency or utility vehicle avoidance process 1700 proceeds to Step 1735. At Step 1735, the emergency or utility vehicle avoidance process 1700 ends.

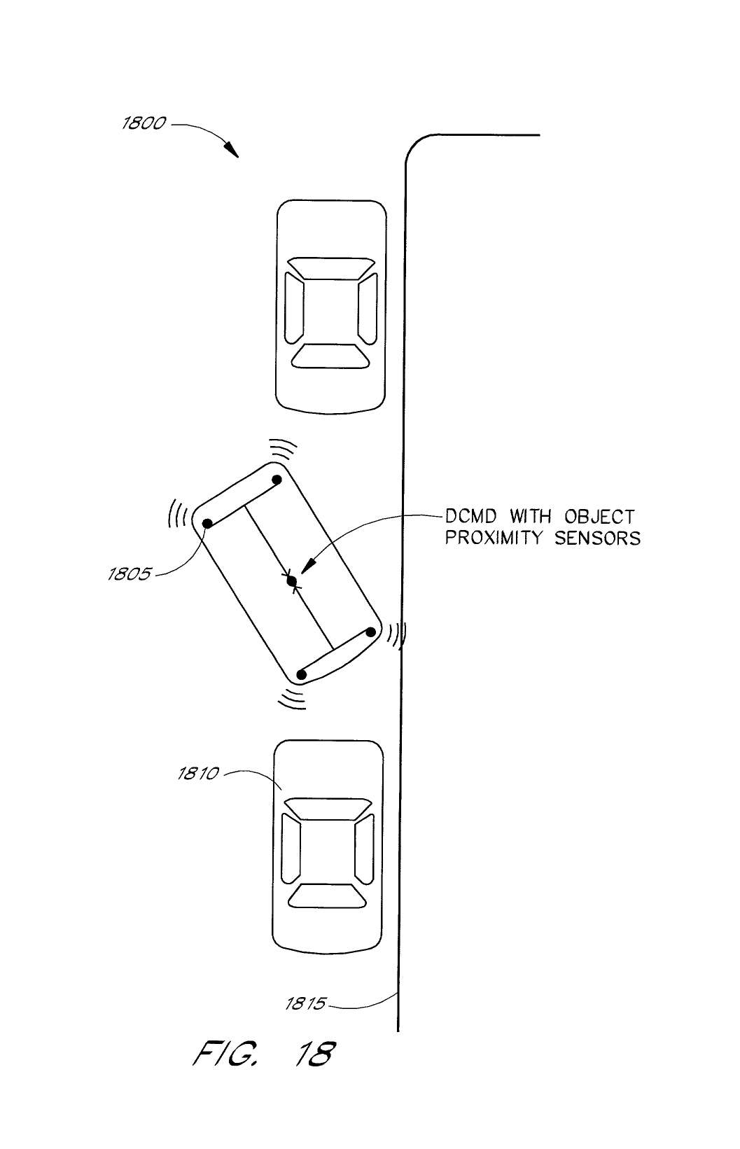

FIG. 18 illustrates a simplified view of a parking assistance device 1800, according to aspects of an embodiment of the invention. In one embodiment of the invention, a motor vehicle carries a DCMD with one or more object proximity sensors 1805. In one embodiment of the invention, the object proximity sensor 1805 comprises a device capable of determining the distance between two or more objects. For example, the objects include a motor vehicle 1810, a curb of a side-walk 1815, a traffic sign, or the like. In one embodiment of the invention, the object proximity sensor 1805 comprises a device capable of transmitting a signal corresponding to the distance between two or more objects. In one embodiment of the invention, the DCMD advantageously receives one or more signals from one or more proximity sensors 1805. The DCMD advantageously analyzes the one or more signals from one or more proximity sensors 1805 to determine the location of the motor vehicle with respect to the objects proximate to the motor vehicle. The DCMD advantageously displays the relative location of the motor vehicle to the occupants of the motor vehicle. Thus, the driver of the motor vehicle may adjust the position of the motor vehicle according to the information received from the DCMD. In this way, the DCMD assists the driver of the motor vehicle in maneuvering the motor vehicle during activities such as, for example, parallel parking, leaving a tight drive-way, driving in reverse, driving with a blocked window, or the like. According to a further embodiment, the mobile DCMD may advantageously output a signal to, for example, the human interface device of FIG. 7, which displays a real-time display similar to that of FIG. 18, thereby visually guiding the user into, for example, a parking position.

FIG. 19 illustrates an accident recording process 1900, according to aspects of an embodiment of the invention. In one embodiment of the invention, the accident recording process 1900 starts at Step 1905. At Step 1910, the DCMD residing on a motor vehicle records visual and audio information about the surrounding of the motor vehicle, and including, according to one embodiment, automobile status parameters, such as engine revolutions, speed, acceleration, deceleration, braking system measurements, diagnostics, or the like. For example, in one embodiment, the DCMD records the visual surroundings of the motor vehicle, the sounds around the motor vehicle, or both. After Step 1910, the accident recording process 1900 proceeds to Step 1915. At Step 1915, if an interrupt has not occurred, the accident recording process 1900 proceeds to Step 1910. At Step 1915, if an interrupt has occurred, the accident recording process 1900 proceeds to Step 1920. In one embodiment of the invention, the interrupt includes any abrupt force or impact applied to the motor vehicle, such as an accident. In another embodiment of the invention, the interrupt may include the activation of a button by the user of the motor vehicle.

At Step 1920, the DCMD stores the recording. The DCMD may preserve the recorded information in various ways. For example, DCMD may preserve the recorded information by storing the recorded information on permanent media, such as for example, solid-state memory, a hard drive, a tape-based memory device, a disk drive, a Flash memory device, or the like. After Step 1920, the accident recording process 1900 proceeds to Step 1930. At Step 1930, the accident recording process 1900 ends.

According to an additional embodiment, the accident recording process 1900 may advantageously record or otherwise preserve automobile operating parameters, such as, for example, status of the braking system, acceleration, decelerations, speed, or the like.

Thus, based on the above, the DCMD may be substantially stationary, such as those adapted for use in a residence, or substantially mobile, such as those adapted for use in an automobile. Moreover, the DCMD may be a complicated computing device capable of a vast number of features and commercial opportunities, or straightforward and designed for specific purposes. In any event, the DCMD allows for efficient content organization, content distribution, and a wide number of commercial opportunities for both businesses and consumers. For example, the localized nature of the transmission devices, along with the straightforward nature of the mobile receiving devices, allow businesses to attract consumers, for example, driving near actual business establishments, while providing users the ability to find business near the users' location offering goods and services which they desire.

Additionally, other combinations, omissions, substitutions, and modifications will be apparent to the skilled artisan in view of the disclosure herein, such as, for example, the replacement of wired for wireless communications, or the like. Accordingly, the invention is not intended to be limited by the preferred embodiments, but is to be defined by reference to the appended claims.

What is claimed is:

1. A digital content management system enabling the continual presentation of content across multiple devices, the digital content management system comprising:
a first device presenting content to one of a first display and a first output device; and
a second device adapted to begin presenting at least a portion of the content to one of a second display and a second output device at a position near the presentation of the first device.

2. The digital content management system of claim 1, wherein the second device is adapted to receive a position indicator from the first device.

3. The digital content management system of claim 1, wherein the second device is adapted to receive a channel ID from the first device.

4. The digital content management system of claim 1, wherein the second device communicates with the first device when the second device is activated.

5. The digital content management system of claim 1, wherein the second device communicates with the first device when a user selects continual presentation of content on the second device.

6. The digital content management system of claim 1, wherein the position corresponds to a point in the presentation by the first device shortly before the second was activated.

7. The digital content management system of claim 1, wherein the position corresponds to a point in the presentation by the first device approximately when the first device is deactivated.

8. The digital content management system of claim 1, wherein the position corresponds to a point in the presentation by the first device shortly before the first device was deactivated.

9. The digital content management system of claim 1, wherein the content comprises one of music, email, voicemail, news, stock quotes, driving directions, audio books or compact discs, and on-line streamed media.

10. The digital content management system of claim 1, wherein the first device comprises a substantially stationary device.

11. The digital content management system of claim 10, wherein communication between the first and second devices comprises wireless communication.

12. The digital content management system of claim 1, wherein the first device comprises a mobile device.

13. The digital content management system of claim 12, wherein communication between the first and second devices comprises wireless communication.

14. The digital content management system of claim 1, wherein the first device comprises a wireless substantially stationary device and the second device comprises a wireless mobile device.

15. The digital content management system of claim 1, wherein a content manager provides the content to at least one of the first and second devices.

16. A method of continuing a presentation of content from a first device to a second device, the method comprising:
receiving a first position of a presentation of content by a first device; and
presenting at least a portion of the content by a second device at a second position, wherein the second position is substantially equal to the first position.

17. The method of claim 16, wherein the first position corresponds to a moment near a time when the first device is deactivated.

18. The method of claim 16, wherein the first position corresponds to a moment near a time when the second device is activated.

19. The method of claim 16, wherein the first device comprises a substantially stationary device.

20. The method of claim 16, wherein the first device comprises a mobile device.

21. The method of claim 16, further comprising transmitting at least a portion of the digital content to the second device.

22. The method of claim 16, wherein the presentation comprises at least one of a visual and audio presentation.

23. A method of continuing a presentation of content from a first device to a second device, the method comprising:
wirelessly communicating with a first device to receive an identifier indicating a source of content being presented by the first device, wherein the content is adaptable for presentation by a second device;
using the identifier to receive at least a portion of the content by the second device from the source; and
presenting the portion of the content by the second device.

24. The method of claim 23, wherein the identifier comprises a channel ID corresponding to a radio transmission and the content includes the radio transmission.

25. The method of claim 24, wherein the radio transmission includes digital radio.

26. A method of managing digital content across multiple devices, the method comprising:
designating at a content manager, first digital content for presentation by a first device;
designating at the content manager, second digital content for presentation by a second device;
transmitting the first digital content to the first device; and
transmitting the second digital content to the second device.

27. The method of claim 26, wherein the transmission to at least the first device comprises wireless transmission.

28. The method of claim 26, wherein the first device comprises a substantially stationary device.

29. The method of claim 26, wherein the first device comprises a mobile device.

30. The method of claim 26, wherein the second digital content comprises at least a portion of the first digital content.

31. A method of synchronizing digital content across multiple devices, the method comprising:
maintaining a first list of content, wherein at least a portion of the content by the first list is designated to be stored on a mobile device;
when the mobile device is within a predetermined proximity, establishing a wireless connection to the mobile device;
receiving, from the mobile device, a second list of content stored on the mobile device; and
downloading over the wireless connection to the mobile device, those portions of content from the first list which are not found in the second list, thereby synchronizing the content from the first list with the content stored on the mobile device.

32. The method of claim 31, further comprising uploading those portions of content from the second list which are not found in the first list.

33. The method of claim 32, further comprising prompting the user to purchase the uploaded content.

34. The method of claim 33, wherein the steps of receiving the second list, uploading, downloading, and prompting the user occur automatically when the wireless connection is established.

35. The method of claim 31, wherein the steps of receiving the second list and downloading the content occur automatically when the wireless connection is established.

36. A method of alerting a user of a mobile computing device that an emergency or utility vehicle is within a predetermined proximity to the mobile computing device, the method comprising:
receiving on a mobile device, a signal transmitted from one of an emergency vehicle and utility vehicle; and
when the mobile device determines that the one of the emergency vehicle and utility vehicle is within a predetermined proximity, alerting the user of the mobile device of the presence of the one of the emergency vehicle and utility vehicle.

37. The method of claim 36, wherein determining the emergency vehicle or utility vehicle is within a predetermined proximity includes determining an amount of power in the received signal.

38. The method of claim 36, wherein determining the emergency vehicle or utility vehicle is within a predetermined proximity includes receiving GPS information from the same.

39. The method of claim 36, wherein the step of alerting the user further comprises reducing an audio level of a presentation of content by the mobile device.

40. The method of claim 36, wherein the utility vehicle includes objects residing on or near a roadway, such as construction signage and detour signage.

41. A method of assisting a driver in positioning of a vehicle, the method comprising:
receiving in a mobile content management device housed in a vehicle, signals from sensor configured to determine a location of an object in proximity to the vehicle; and
presenting to a driver of the vehicle an indication of the location of the vehicle with respect to the object.

42. The method of claim 41, wherein the object in proximity to the vehicle is a second vehicle.

43. The method of claim 41, wherein the object in proximity to the vehicle is a portion of the sidewalk.

44. A method of recording information related to the surroundings of a vehicle, the method comprising:
recording in a rewritable memory, information associated with surroundings of a vehicle;
determining whether an interrupt has occurred;
when an interrupt has occurred, storing at least a portion of the information stored in the rewritable memory, in a computer readable medium.

45. The method of claim 44, wherein the interrupt comprises user activation of an input button on a mobile device.

46. The method of claim 44, wherein the interrupt comprises a impact sensor.

47. The method of claim 44, wherein the recording comprises cyclically recording such that most recently recorded information overwrites the oldest recorded information.

48. The method of claim 44, wherein the information about the surrounding of the vehicle is recorded using a sound recording device.

49. The method of claim 44, wherein the information about the surrounding of the vehicle is recorded using a camera.

50. The method of claim 44, wherein the information comprises information associated with parameters of the vehicle.

51. The method of claim 50, wherein the parameters include at least one of speed, direction, engine revolutions, acceleration, and deceleration.
